(19) United States
(12) Patent Application Publication
(10) Pub. No.: US 2010/0169266 A1
(43) Pub. Date: Jul. 1, 2010

(54) DATA-OVERLAP ANALYSIS FOR A DATA-WAREHOUSING SYSTEM

(76) Inventor: William Bishop, LaFayette, CA (US)

Correspondence Address: JAMES M. STOVER;TERADATA CORPORATION, 2835 MIAMI VILLAGE DRIVE, MIAMISBURG, OH, 45342, US

(21) Appl. No.: 12/648,523

(22) Filed: Dec. 29, 2009

Related U.S. Application Data
(60) Provisional application No. 61/141,788, filed on Dec. 31, 2008.

(51) Int. Cl. G06F 17/30

(52) U.S. Cl. 707/602; 707/E17.044

(57) ABSTRACT

A computer system is used to manage content in a database system that stores data representing data elements defined by a logical data model. For at least one of multiple business functions to be carried out with the database system, the computer system (1) identifies a total amount of data elements required to carry out the business function, (2) identifies an amount of common data elements that are required to carry out both the business function and another of the multiple business functions, (3) creates information that indicates a percentage of the total amount of data elements that are also common data elements, and (4) delivers the information for presentation to a human user.

### CROSS-REFERENCE TO RELATED APPLICATIONS

This application claims priority from U.S. Provisional Application 61/141,788, filed on Dec. 31, 2008, by William V. Bishop.

### BACKGROUND

Data warehousing systems are very large database systems used to store and analyze data from across many aspects of a company's business operations. Quite often, nearly all of the data collected by a company from all areas of its business operations is stored in a single system, known as an enterprise data warehouse (EDW), operating under a single database schema. These database systems almost always store data sets that would be useful in analyzing multiple aspects of the company's business operations, but the company often does not understand the cross-functional applicability of the data it possesses. The result is that companies typically underutilize the data in their data-warehousing systems and fail to perform all types of analysis available to them with the data that they have. Companies also fail to understand that, in many cases, the addition of relatively small amounts of data their data-warehousing system would open up areas of analysis that they did not know were so easily attainable.

### SUMMARY

A computer system is used to manage content in a database system that stores data representing data elements defined by a logical data model. For at least one of multiple business functions to be carried out with the database system, the computer system (1) identifies a total amount of data elements required to carry out the business function, (2) identifies an amount of common data elements that are required to carry out both the business function and another of the multiple business functions, (3) creates information that indicates a percentage of the total amount of data elements that are also common data elements, and (4) delivers the information for presentation to a human user.

Other features and advantages will become apparent from the description and claims that follow.

### BRIEF DESCRIPTION OF THE DRAWINGS

FIG. 1 is a schematic diagram showing a sample architecture for a data warehousing system.

FIG. 2 is a diagram showing a logical data model for use in organizing data within the data warehouse.

FIG. 3 is a diagram showing a model for grouping the data elements of the logical data model according to the various business questions that they answer and for grouping the business questions into multiple business functions to which they are relevant.

FIG. 4 is a diagram showing a mapping of business questions to the data elements required to answer them.

FIG. 5 is a diagram showing a mapping of business questions to the business functions to which they apply.

FIG. 6 is a diagram showing the results of a data-overlap analysis for the business functions of FIG. 5.

FIG. 7 is a schematic diagram of a computer system for use in performing data-overlap analysis.

### DETAILED DESCRIPTION

Described below is a technique for use in helping a human user of a data-warehousing system understand the extent to which the data needed to perform a certain business function also enables performance of some other business function. The technique involves the performance of a data-overlap analysis to assess the amount of overlap in data required for carrying out one business function with that required to carry out another business function. For example, such an analysis might indicate the percentage of data necessary for performing a first business function (BF1) that is present in the data warehouse if all of the data necessary for performing a second business function (BF2) were present. Likewise, the data-overlap analysis might indicate the percentage of data needed for BF2 that is available when all of the data needed for BF1 is present. One result is that a company using the data-warehousing system receives an immediate view of the overlap that exists within the data warehouse among the data elements required to perform the various business functions supported by the data warehouse. This often leads to a recognition by the company that it has sufficient data available to perform a business function or a type of business analysis that it did not previously know it had.

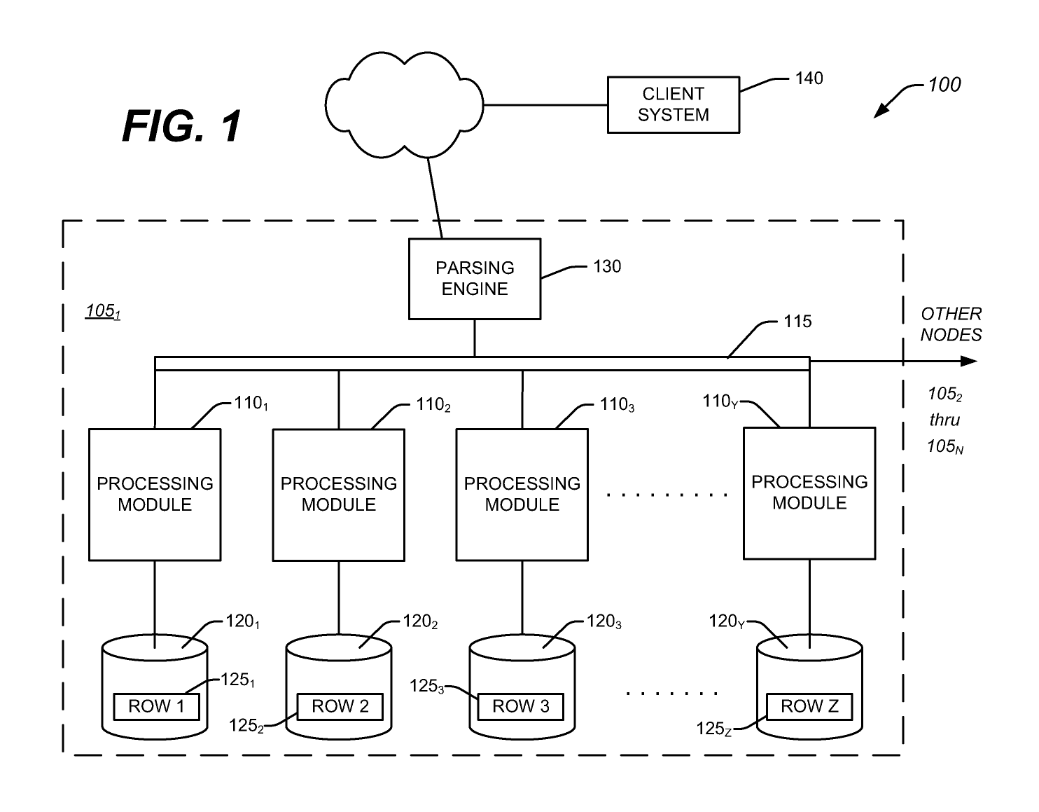

One type of database system that is particularly well suited to the overlap-analysis technique described below is one that uses parallel architecture to implement an enterprise-wide data warehouse. One such system is the Teradata Active Data Warehouse system available from Teradata Corporation. FIG. 1 shows one of many massively parallel nodes 105_{1-N} that typically make up such a database system 100. The node 105₁ shown in FIG. 1 includes one or more processing modules 110_{1-Y} that are connected by an network 115 (or interconnect fabric) and that manage the storage and retrieval of data in data-storage facilities 120_{1-Y}. Each of the processing modules 110_{1-Y} may be one or more physical processors, or each may be a virtual processor, with one or more virtual processors running on one or more physical processors.

For the case in which one or more virtual processors are running on a single physical processor, the single physical processor swaps between the set of virtual processors. For the case in which Y virtual processors are running on an X-processor node, the node's operating system schedules the Y virtual processors to run on its set of X physical processors. If there were, for example, four virtual processors and four physical processors, then typically each virtual processor would run on its own physical processor. If there were eight virtual processors and four physical processors, the operating system would schedule the eight virtual processors against the four physical processors, in which case swapping of the virtual processors would occur.

Each of the processing modules 110_{1-Y} manages a portion of a database that is stored in a corresponding one of the data-storage facilities 120_{1-Y}. Each of the data-storage facilities 120_{1-Y} includes one or more storage devices, typically in the form of disk drives. In most embodiments, the database system 100 includes many parallel nodes 105_{2-N} in addition to the node 105₁ shown here, all connected together through an extension of the network 115.

The database system 100 as shown here stores data in one or more tables in the data-storage facilities 120_{1-Y}. The rows 125_{1-Z} of the tables are stored across multiple data-storage facilities 120_{1-Y} to ensure that the system workload is distributed evenly across the processing modules 110_{1-Y}. A parsing engine 130 organizes the storage of data and the distribution of table rows 125_{1-Z} among the processing modules 110_{1-Y}. The parsing engine 130 also coordinates the retrieval of data from the data-storage facilities 120_{1-Y} in response to queries received from a user at a mainframe or a client computer 140. The database system 100 usually receives queries and commands in a standard query format, such as the Structured Query Language (SQL).

In some systems, the rows 125_{1-Z} of the tables are distributed across the data-storage facilities 120_{1-Y} by the parsing engine 130 in accordance with their primary index. The primary index defines which columns in the tables, and thus which entries in the rows 125_{1-Z}, are used for row distribution. Quite often, row distribution is accomplished by applying a hashing function to the columns identified by the primary index, producing a hash value for each of the rows. The hash values are assigned to the data-storage facilities 120_{1-Y} and associated processing modules 110_{1-Y} by a hash map. The characteristics of the columns chosen for the primary index determine how evenly the rows are distributed among the processing modules 110_{1-Y} and data-storage facilities 120_{1-Y}.

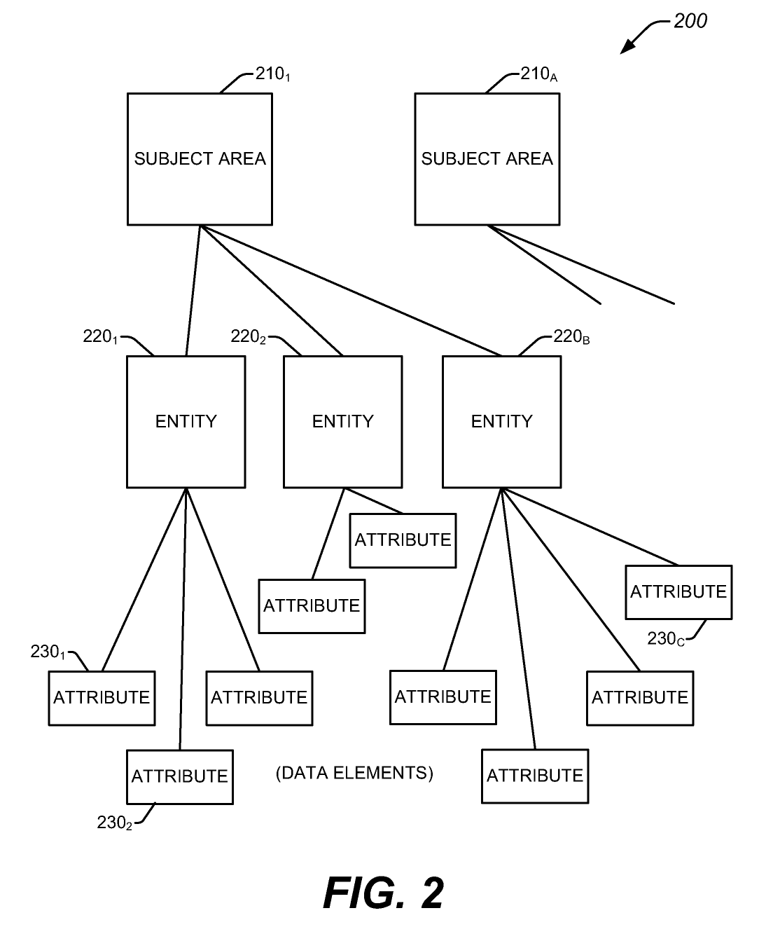

FIG. 2 shows a logical data model 200 of the type that would be used to populate and organize data in the data warehouse of FIG. 1. The logical data model 200 defines one or more subject areas 210_{1-A} that are of interest to the company that uses the data warehouse. Within each subject area 210_{1-A}, the logical data model 200 defines entities 220_{1-B} that each specifies a grouping of data objects in a manner that preserves relationships among those objects. The logical data model also defines attributes 230_{1-C} (or “data elements”) that make up each of the entities, as well as the relationships that exist among the entities 220_{1-B} and attributes 230_{1-C}.

In most systems, the entities 220_{1-B} defined by the logical data model 200 each represents a database table within the data warehouse, and the attributes 230_{1-C} within each entity represent the columns that make up the table. The attributes defined by the logical data model 200 therefore typically define the lowest level of granularity at which data is stored within each record (row) in the database—the “data elements” that occupy the cells of each row in the database. Logical data models are well understood by those of ordinary skill in the art and thus are not described in any more detail here.

As an example, a financial institution (such as a bank) might create a logical data model to organize its enterprise data warehouse into a variety of subject areas, such as customer accounts, institutional holdings, and personnel records. Within the area of customer accounts, the bank might define entities that correspond to the various banking products it offers—checking accounts, savings accounts, loan accounts, etc. In most data warehousing systems, each of these entities is represented by a database table—e.g., a “checking accounts” table, a “savings accounts” table, and a “loan accounts” table—with each table containing (for example) a list of all customers of the bank who hold that type of account. The attributes defined by the logical data model would then specify the pieces of information (the data elements) to be stored in the columns of each of these tables—e.g., customer name, customer ID, account number, and current balance for each account held.

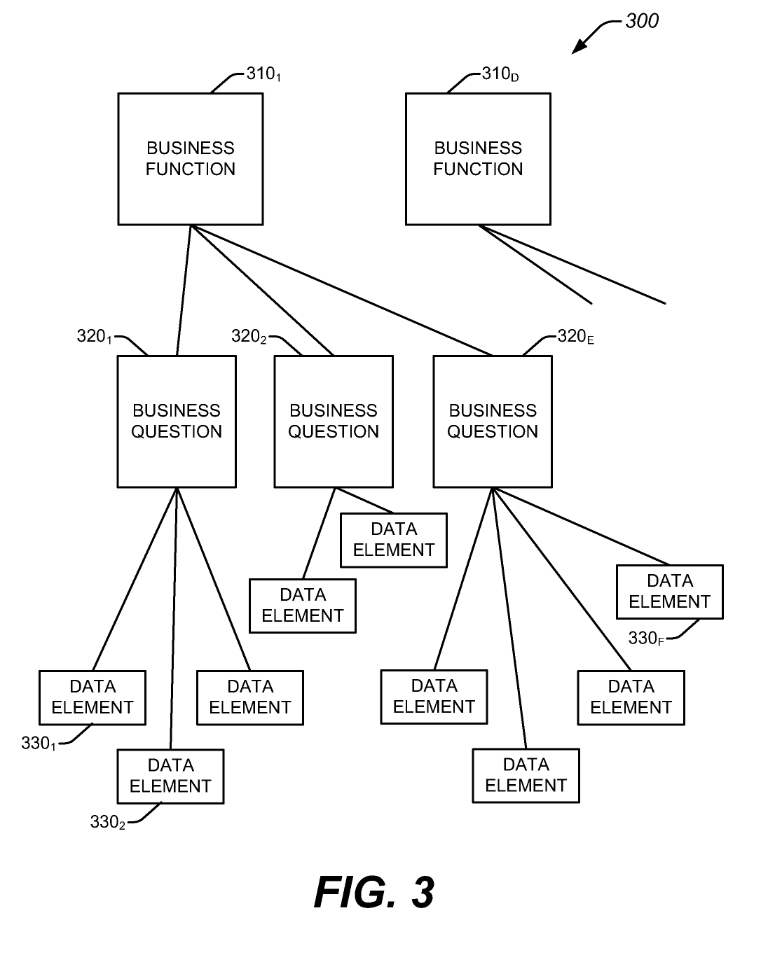

FIG. 3 shows a business-function model 300 that describes the relationships among the various business functions 310_{1-D} that the company uses the data warehouse to carry out and the business questions 320_{1-E} that must be addressed to carry out each business function. The business functions often take the form of certain business capabilities that the company wishes to understand or areas of analysis that the company wishes to focus on. For example, a banking institution might identify the following as business functions to be carried out by the data warehouse: Anti-Money Laundering (AML) Surveillance, Credit Risk Intervention, Customer Account Behavior, and Staff Performance Management. Within the area of Credit Risk Intervention, the bank might conclude that several business questions must be answered to fully analyze the issue, including the following:

1. What is the current mortgage loan-to-value by credit-score group?

2. What is the mortgage delinquency status by credit score?

3. What are the loan-to-value ratios by customer representative?

Within the area of Staff Performance Management, the bank might conclude that business questions such as the following must be answered:

1. What is the mortgage delinquency status by credit score?

2. What are the loan-to-value ratios by customer representative?

3. What is the net value per loan by customer representative?

In this example, Questions 2 and 3 for the Credit Risk Intervention function are the same as Questions 1 and 2 for the Staff Performance Management function. The significance of this overlap among the business functions is described in more detail below.

The business-function model 300 of FIG. 3 also describes the relationships between the business questions 320_{1-E} to be answered and the data elements 330_{1-F} that are needed to answer those questions. The data elements 330_{1-F} shown here are selected from the data elements represented by the attributes that are defined in the logical data model of FIG. 2. The business-function model 300 therefore shows, for each business function 310_{1-D} to be carried out by the data warehouse, which data elements 330_{1-F} are required to perform the full analysis called for by the business function.

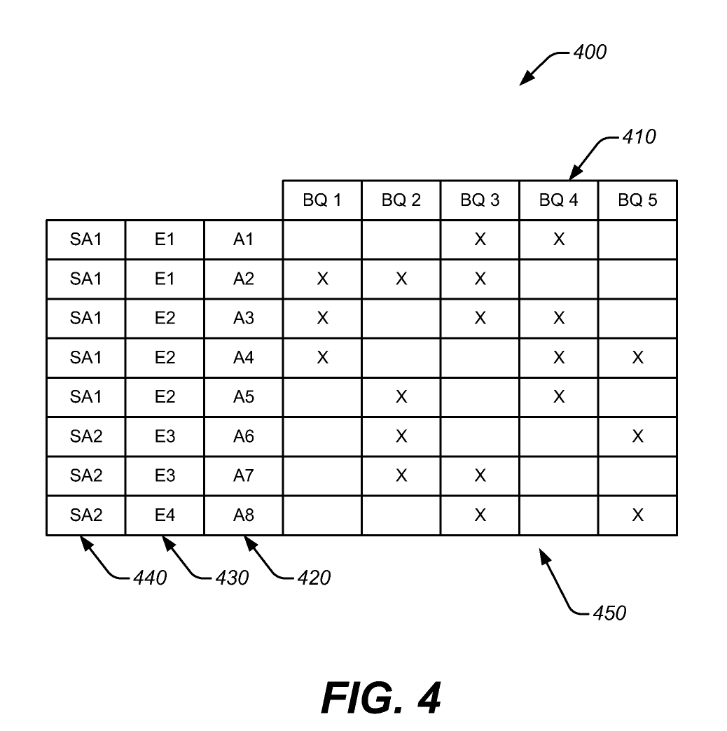

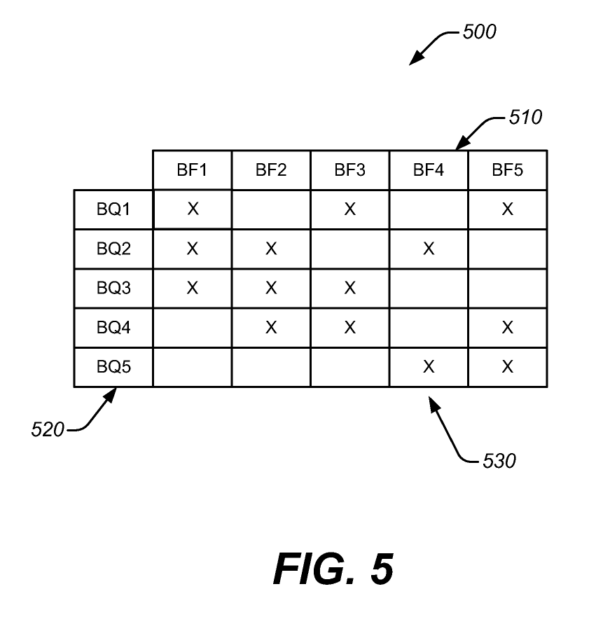

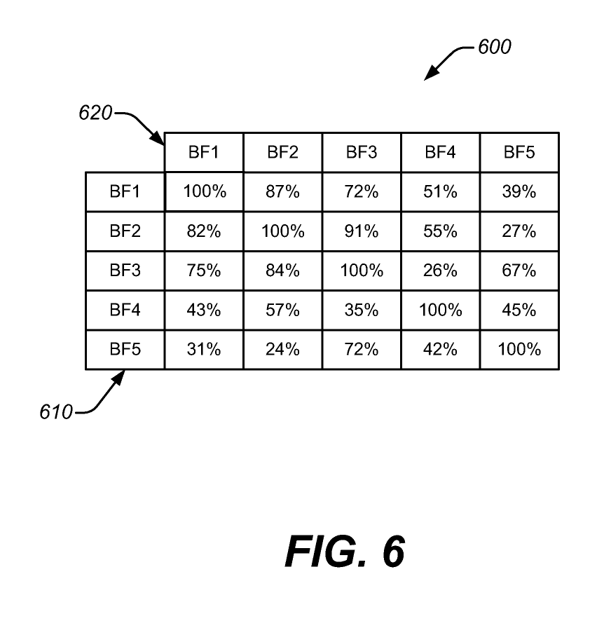

FIGS. 4, 5 and 6 together illustrate through example a computer-implemented technique for performing data-overlap analysis on the various business functions to be carried out by the data warehouse. In short, the technique involves three primary steps: (1) creating a mapping of the various business questions to be answered and the attributes (or data elements) required to answer them (FIG. 4); (2) creating a mapping of the various business functions to be carried out with the data warehouse and the business questions that must be answered for each of them (FIG. 5); and (3) calculating, for each pair of business functions, the percentage of data elements required by one business function that are present if all data elements required for the other business function are present (FIG. 6). These steps are all carried out by a computer system, either automatically without human intervention or in dialog with a human user through a graphical user interface. A computer system suitable for use in performing the data-overlap analysis is described in more detail below.

FIG. 4 shows a “required-elements” map 400 that the computer system generates by drawing information from the logical data model of FIG. 2 and the business-function model 300 of FIG. 3. The required-elements map 400 lists in one dimension all of the business questions 410 to be answered by the data warehouse and in the other dimension all of the attributes 420 (or data elements) required to answer the business questions. In some embodiments, the required-elements map 400 also shows the entities 430 and subject areas 440 to which each of the attributes 420 belongs. Within its cells 450, the required-elements map 400 identifies which of the listed attributes 420 is needed to answer each of the listed business questions 410. The required-elements map 400 can be implemented in a variety of ways, such as with a spreadsheet or in a database table.

As shown in the example of FIG. 4, there is often overlap among the data elements that are required for each pair of business questions to be answered. For example, BQ1 and BQ2 share at least one common data element, A2; BQ3 and BQ4 share at least two common data elements, A1 and A3. This overlap becomes significant in the portion of the analysis depicted in FIG. 6.

FIG. 5 shows a “required-questions” map 500 that the computer system creates by drawing information from the business-function model of FIG. 3 and the required-elements map of FIG. 4. The required-questions map 500 lists in one dimension all of the business functions 510 that are to be carried out by the data warehouse and in the other dimension all of the business questions 520 to be answered by the data warehouse. Within its cells 530, the required-questions map 500 identifies which of the listed business questions 520 must be answered to perform each of the listed business functions 510. As with the required-elements map of FIG. 4, the required-questions map can be implemented in a variety of ways, including with a spreadsheet or a database table.

As shown in FIG. 5, there is often overlap among the business questions that are required for each pair of business functions. For example, BF1 and BF2 share at least two common business questions, BQ2 and BQ3. Likewise, BF3 and BF5 share at least two common business questions, BQ1 and BQ4. As with the overlap among data elements described above, this overlap among business questions becomes significant in the portion of the analysis depicted in FIG. 6.

FIG. 6 shows an “overlap-analysis” map 600 that the computer system creates by drawing information from the required-elements map of FIG. 4 and the required-questions map of FIG. 5. The overlap-analysis map 600 shows, for each of the business functions to be carried out by the data warehouse, the percentage of data elements required by the business function that are common to each of the other business functions. Put another way, the overlap-analysis map 600 answers the question: “If the data warehouse contains all of the data elements required to perform business function A, what percentage of the data elements required for business function B must also be present?”

The overlap-analysis map 600 lists in each dimension all of the business functions to be carried out by the data warehouse. In filling the cells of the overlap-analysis map 600, the computer system calculates the total number of data elements required to carry out each business function. The computer system also calculates the total number of common data elements between each pair of business functions. The computer system then calculates, for each cell in the map, the ratio of common data elements between the two business functions to total data elements required by the business function listed in the vertical dimension 610 and stores this ratio in the cell as a percentage.

For example, in the first cell of the map (upper-left corner), business function BF1 is listed in both dimensions. Because each business function has complete overlap with itself, the value in the first cell is 100% (signifying that BF1 has 100% overlap with BF1). In the second cell of the map (the one immediately to the right of the first cell), BF1 is listed in the vertical dimension 610, and BF2 is listed in the horizontal dimension 620. The computer system fills this cell by dividing the number of data elements common to BF1 and BF2 by the total number of data elements required by BF1. This calculation produces a result of 87% in this example, meaning that if all of the data elements required for BF2 are present, then at least 87% of the data elements required for BF1 are present. Likewise, the cell lying immediately below the first cell indicates that, if all of the data elements required for BF1 are present, then at least 82% of the data elements required for BF2 are present.

The computer system fills all of the cells in the overlap-analysis map 600 in this manner and at some point thereafter presents the map to a human user through a graphical display. The result is that the human user gains an immediate understanding of the amount of overlap that exists among the business functions to be carried out by the data warehouse and therefore is able to make more effective and efficient use of the data warehouse.

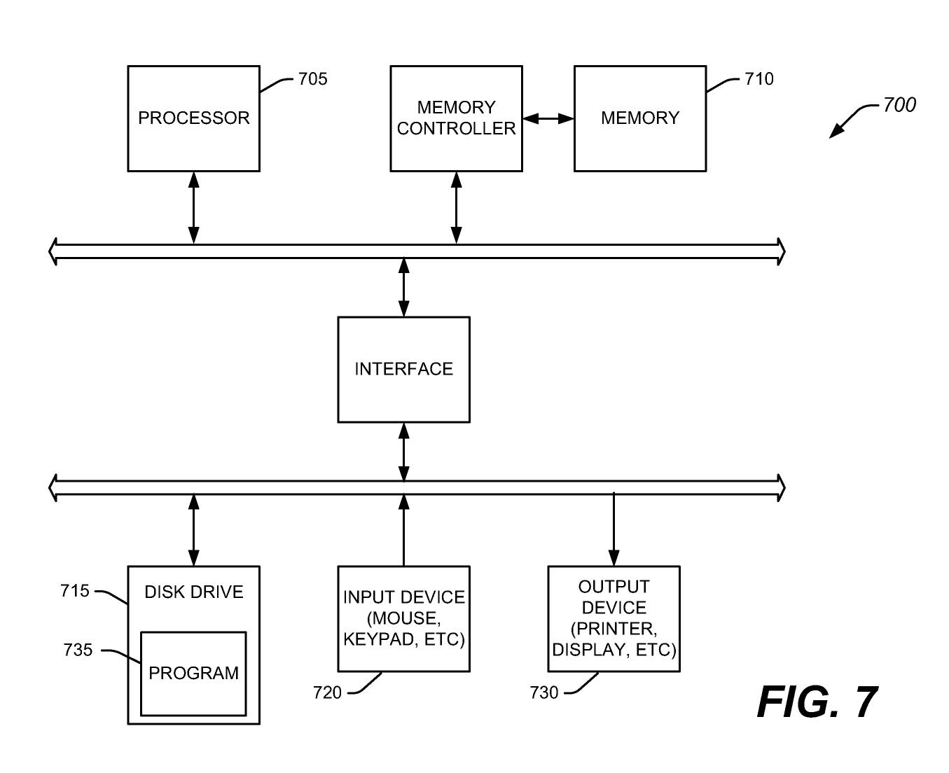

FIG. 7 shows a computer system 700 suited for use in carrying out the overlap-analysis technique. The computer system 700 may form a part of the data-warehousing system itself, or it may lie outside the data-warehousing system and communicate with the data-warehousing system through some interconnection protocol.

In general, the computer system 700 includes one or more processors 705, one or more temporary data-storage components 710 (e.g., volatile and nonvolatile memory modules), one or more persistent data-storage components 715 (e.g., optical and magnetic storage devices, such as hard and floppy disk drives, CD-ROM drives, and magnetic tape drives), one or more input devices 720 (e.g., mice, keyboards, and touch-screens), and one or more output devices 730 (e.g., display consoles and printers). The computer system 700 includes executable program code 735 that is usually stored in the one or more persistent data-storage components 715 and then copied into the one or more temporary storage components 710 at run-time. The one or more processors 705 execute the code by retrieving program instructions from temporary storage in a prescribed order. When executing the program code, the computer receives data from the input and/or storage devices, performs operations on the data, and then delivers the resulting data to the output and/or storage devices.

In some embodiments, the computer is a special-purpose computer that performs only certain, specialized functions. In other embodiments, the computer is a general-purpose computer programmed to perform the functions needed by the service establishment.

The text above describes one or more specific embodiments of a broader invention. The invention also is carried out in a variety of alternative embodiments and thus is not limited to those described here. Many other embodiments are also within the scope of the following claims.

1. A computer-implemented method for enabling a user at a user terminal to manage content in a database system that stores data representing data elements defined by a logical data model, the method comprising:
for at least one of multiple business functions to be carried out with the database system:
identifying a total amount of data elements required to carry out the business function;
identifying an amount of common data elements that are required to carry out both the business function and another of the multiple business functions; and
creating information that indicates a percentage of the total amount of data elements that are also common data elements; and
delivering the information to the user terminal for presentation to the user.

2. The method of claim 1, further comprising storing data that identifies:
one or more business questions that must be answered in carrying out the business function; and
the data elements that are required to answer each of the business questions.

3. The method of claim 1, further comprising storing data that identifies:
one or more business questions that must be answered in carrying out the other business function; and
the data elements that are required to answer each of the business questions required for the other business function.

4. The method of claim 1, further comprising:
identifying a total amount of data elements required to carry out the other business function;
creating information that indicates a percentage of the total amount of data elements required for the other business function that are also common data elements; and
delivering the information to the user terminal for presentation to the user.
